(19) United States
(12) Patent Application Publication
(10) Pub. No.: US 2026/0205508 A1
(43) Pub. Date: Jul. 16, 2026

(54) LIVESTREAM DEVICE AND METHOD THEREOF

(71) Applicant: NIMBLETECH DIGITAL INC., New Taipei City (TW)

(72) Inventor: Chih-Yang CHEN, New Taipei City (TW)

(21) Appl. No.: 19/442,948

(22) Filed: Jan. 7, 2026

(30) Foreign Application Priority Data
Jan. 8, 2025 (TW) 114100789

(51) Int. Cl. H04L 65/75

(52) U.S. Cl. CPC H04L 65/765

(57) ABSTRACT

A network livestream device includes a processing component, a plurality of decoding components, a display engine, and a Universal Serial Bus (USB) component. The plurality of decoding components receive live streaming audio and video data generated by at least one streaming terminal. The processing component determines a number of the streaming terminals and activates a corresponding number of decoding components to decode the live streaming audio and video data to generate decoded live streaming audio and video data. The display engine adjusts a resolution of the decoded live streaming audio and video data to form streamed stitched image data. The USB component performs format conversion on the streamed stitched image data to generate USB-format live streaming audio and video data and transmits the USB-format live streaming audio and video data to a client terminal.

### BACKGROUND

### Technical Field

The present invention relates to a network system and method, and more particularly to a network livestream device and method.

### Description of Related Art

With the increasing use of computer networks and the continuous growth of network bandwidth, network live streaming—by streaming audio and video content to end users—has become a rapidly growing market. Whether for selling products, providing real-time commentary on current events, or conducting live game streaming and analysis, network live streaming applications are expanding quickly. Moreover, driven by consumers' demand for interactive live video experiences, an increasing number of sellers and commentators are using live streaming to interact with consumers.

However, implementing a live streaming scenario typically requires a large amount of additional hardware configuration and integration. In addition, consumer mobile devices operate on different platform systems, which often results in compatibility issues. In particular, when multiple different audio and video signals are required to be streamed over a network, multiple audio and video input/output devices—such as cameras and microphones—as well as complex cable adapters corresponding to different devices are required. This causes inconvenience to users and increases costs.

Accordingly, how to improve the drawbacks of existing implementation approaches has become a key issue.

### SUMMARY

According to one aspect of the present disclosure, a network livestream device includes a processing component; a plurality of decoding components coupled to the processing component and configured to receive live streaming audio and video data generated by at least one streaming terminal, wherein the processing component determines a number of the at least one streaming terminal and activates a corresponding number of the plurality of decoding components to decode the live streaming audio and video data to generate decoded live streaming audio and video data; a display engine coupled to the plurality of decoding components and configured to adjust a resolution of the decoded live streaming audio and video data to form streamed stitched image data; and a Universal Serial Bus (USB) component coupled to the display engine and configured to perform format conversion on the streamed stitched image data to generate USB-format live streaming audio and video data and transmit the USB-format live streaming audio and video data to at least one client terminal.

In some embodiments, the network livestream device further includes a memory component coupled to the plurality of decoding components and configured to temporarily store the decoded live streaming audio and video data.

In some embodiments, the network livestream device further includes a communication component coupled to the Universal Serial Bus component and configured to transmit the streamed stitched image data to a website.

In some embodiments, the network livestream device further includes a high-definition multimedia interface configured to output the streamed stitched image data.

In some embodiments, the network livestream device further includes an audio input interface configured to be coupled to an audio input device.

In some embodiments, the decoded live streaming audio and video data includes at least one live streaming audio and video data generated by different streaming terminals, and the display engine further includes: an image stitching module configured to adjust resolutions of the at least one live streaming audio and video data to form at least one adjusted image data and to combine the at least one adjusted image data into stitched image data; and an image streaming module coupled to the image stitching module and configured to stream the stitched image data to form the streamed stitched image data.

In some embodiments, the image stitching module adjusts the resolutions of the at least one live streaming audio and video data using a scaling function.

According to another aspect of the present disclosure, a network live streaming method includes: receiving live streaming audio and video data generated by at least one streaming terminal, wherein a processing component determines a number of the at least one streaming terminal and activates a corresponding number of a plurality of decoding components to decode the live streaming audio and video data to generate decoded live streaming audio and video data; adjusting a resolution of the decoded live streaming audio and video data to form streamed stitched image data; and performing format conversion on the streamed stitched image data to generate USB-format live streaming audio and video data to transmit to at least one client terminal.

In some embodiments, the network live streaming method further includes transmitting the USB-format live streaming audio and video data to a website.

In some embodiments, the decoded live streaming audio and video data includes at least one live streaming audio and video data generated by different streaming terminals, and the network live streaming method further includes: adjusting resolutions of the at least one live streaming audio and video data to form at least one adjusted image data and combining the at least one adjusted image data into stitched image data; and streaming the stitched image data to form the streamed stitched image data.

The present disclosure provides a network livestream device and method that are capable of directly receiving live streaming audio and video data in different formats from one or more streaming terminals, decoding this data, and converting the decoded data into USB-format for use in network streaming, so as to output the USB-format data to other playback devices. Therefore, a broadcaster does not need to prepare different capture devices or adapter cables to capture live streaming audio and video data in different formats, thereby significantly reducing the burden and inconvenience associated with live streaming.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram of a network live streaming system according to a preferred embodiment of the present invention.

FIG. 2 is a schematic diagram of a network livestream device according to a preferred embodiment of the present invention.

FIG. 3 is a flowchart of a network live streaming method according to a preferred embodiment of the present invention.

### DETAILED DESCRIPTION

The spirit of the present disclosure will be clearly explained below with reference to drawings and detailed descriptions. After understanding the embodiments of the present disclosure, any person having ordinary skill in the art may make various modifications and alterations based on the teachings of the present disclosure without departing from the spirit and scope thereof.

The terminology used herein is for the purpose of describing particular embodiments only and is not intended to be limiting of the present disclosure. As used herein, the singular forms “a,” “an,” and “the” include plural forms as well, unless the context clearly indicates otherwise.

As used herein, the terms “coupled” or “connected” may refer to two or more elements or devices being in direct physical contact with each other, in indirect physical contact with each other, or in operative association with each other.

As used herein, the terms “comprise,” “include,” “have,” “contain,” and the like are open-ended terms, meaning “including but not limited to.”

As used herein, the term “and/or” includes any and all combinations of one or more of the associated listed items.

Unless otherwise specifically defined, the terms used herein generally have the ordinary meanings as understood in the art to which the present disclosure pertains and in the context of the present disclosure and the specific content thereof. Certain terms used to describe the present disclosure will be discussed below or elsewhere in this specification to provide additional guidance to those skilled in the art regarding the description of the present disclosure.

Conventionally, implementing a live streaming scenario usually requires a large amount of additional hardware configuration and integration. In addition, consumer mobile devices operate on different platform systems, which often results in compatibility issues. Accordingly, the present disclosure provides a network livestream device and method that are capable of directly receiving live streaming audio and video data in different formats from one or more streaming terminals, decoding this data, and converting the decoded data into USB-format for use in network streaming, so as to output the USB-format data to other playback devices. Therefore, a broadcaster does not need to prepare different capture devices or adapter cables to capture live streaming audio and video data in different formats, thereby significantly reducing the burden and inconvenience associated with live streaming.

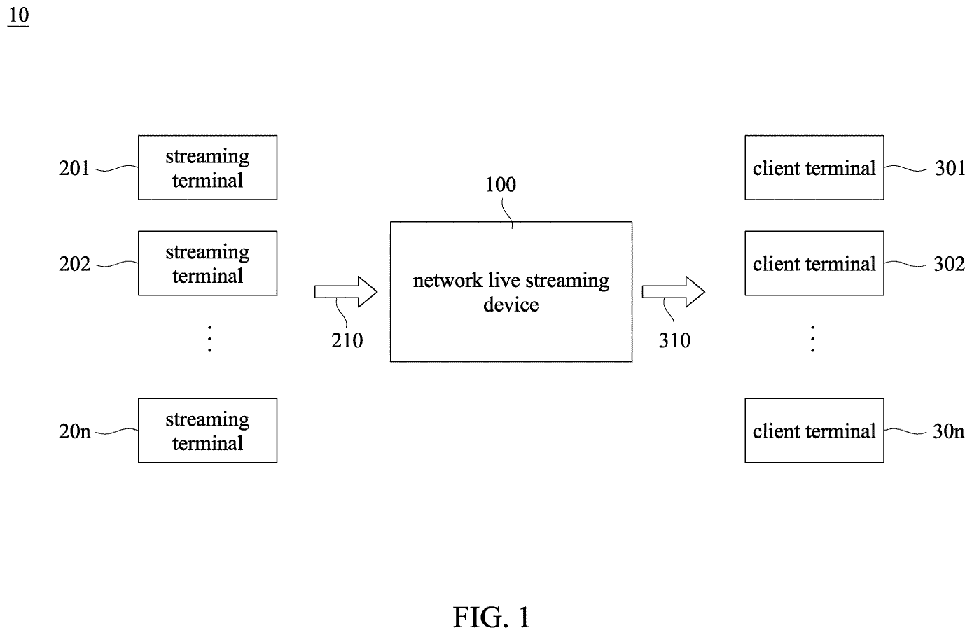

FIG. 1 is a schematic diagram of a network live streaming system according to a preferred embodiment of the present disclosure. The network live streaming system 10 includes a network livestream device 100, at least one streaming terminal 201, 202, . . . 20n, and at least one client terminal 301, 302, . . . 30n. In some embodiments, the network livestream device 100 is communicatively connected to the at least one streaming terminal 201, 202, . . . 20n and the at least one client terminal 301, 302, . . . 30n via wired or wireless means. In some embodiments, the network livestream device 100 is configured to receive live streaming audio and video data 210 transmitted from the streaming terminals 201, 202, . . . 20n, convert the live streaming audio and video data 210 into USB-format live streaming audio and video data 310 to transmit to the at least one client terminal 301, 302, . . . 30n. It should be noted that the live streaming audio and video data 210 includes live streaming audio and video data generated by different streaming terminals 201, 202, . . . 20n. In some embodiments, when the live streaming audio and video data 210 includes live streaming audio and video data generated by at least two streaming terminals 201, 202, . . . 20n, the network livestream device 100 further stitches the live streaming audio and video data generated by the at least two streaming terminals, such that the display interface of the client terminals 301, 302, . . . 30n can simultaneously display the live streaming audio and video data generated by the at least two streaming terminals. In some embodiments, the streaming terminals 201, 202, . . . 20n may be electronic devices having audio and video capturing capabilities, such as smart devices including mobile phones with cameras, tablet computers, or computers. The client terminals 301, 302, . . . 30n may be electronic devices having display interfaces, such as mobile phones, tablet computers, or computers. In some embodiments, the at least one streaming terminal 201, 202, . . . 20n is responsible for capturing audio and video at a live scene in real time to obtain the live streaming audio and video data 210 and uploading the live streaming audio and video data 210 to the network livestream device 100. The network livestream device 100 converts the live streaming audio and video data 210 into USB-format live streaming audio and video data 310 and transmits the data to the at least one client terminal 301, 302, . . . 30n.

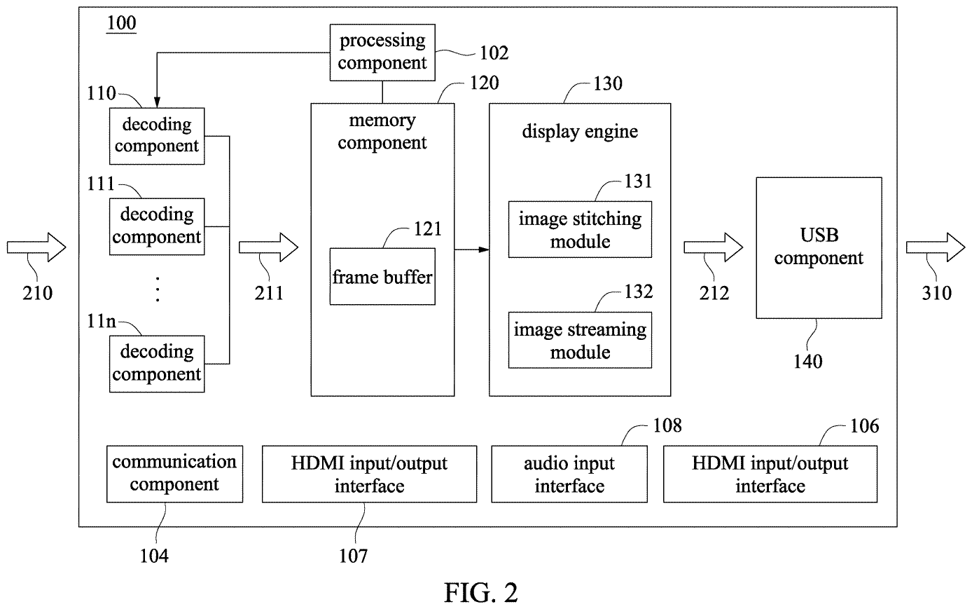

FIG. 2 is a schematic diagram of a network livestream device according to a preferred embodiment of the present disclosure. The network livestream device 100 includes a processing component 102, a plurality of decoding components 110, 111, . . . 11n, a memory component 120, a display engine 130, and a Universal Serial Bus (USB) component 140. Reference is made to FIG. 1 and FIG. 2 concurrently.

In some embodiments, the plurality of decoding components 110, 111, . . . 11n receive the live streaming audio and video data 210 formed by the audio and video captured at the live scene by the at least one streaming terminal 201, 202, . . . 20n. In some embodiments, the at least one streaming terminal 201, 202, . . . 20n encodes the live streaming audio and video data 210 and transmits the encoded live streaming audio and video data 210 to the network livestream device 100 for decoding. In some embodiments, the plurality of decoding components 110, 111, . . . 11n decode the encoded live streaming audio and video data 210 to generate decoded live streaming audio and video data 211.

In some embodiments, the processing component 102 is coupled to the plurality of decoding components 110, 111, . . . 11n. The processing component 102 is configured to determine the number of streaming terminals 201, 202, . . . 20n generating the live streaming audio and video data 210, and to activate a corresponding number of decoding components 110, 111, . . . 11n for decoding. In some embodiments, if the live streaming audio and video data 210 includes live streaming audio and video data generated by only one streaming terminal, the processing component 102 activates one of the decoding components 110, 111, . . . 11n. If the live streaming audio and video data 210 includes live streaming audio and video data generated by multiple streaming terminals, the processing component 102 activates a corresponding number of decoding components 110, 111, . . . 11n according to the number of streaming terminals generating the live streaming audio and video data. In some embodiments, when the live streaming audio and video data 210 includes live streaming audio and video data generated by two streaming terminals, such as an iPhone mobile phone and an Android mobile phone, the processing component 102 activates corresponding decoding components based on the encoding and decoding protocols of the iPhone and Android streaming terminals to decode the live streaming audio and video data. In some embodiments, the processing component 102 may be a central processing unit (CPU), a general-purpose processor, or the like, but the present disclosure is not limited thereto.

In some embodiments, the memory component 120 is coupled to the plurality of decoding components 110, 111, . . . 11n, and a portion of the memory component 120 may serve as a frame buffer 121. In some embodiments, the frame buffer 121 temporarily stores the decoded live streaming audio and video data 211 from the plurality of decoding components 110, 111, . . . 11n. The memory component 120 may be a random-access memory, such as dynamic random-access memory (DRAM) or static random-access memory (SRAM), but the present disclosure is not limited thereto.

The display engine 130 is coupled to the memory component 120 and is configured to perform stitching processing on the live streaming audio and video data 210 generated by multiple streaming terminals. In some embodiments, if the decoded live streaming audio and video data 211 includes live streaming audio and video data 210 generated by multiple streaming terminals 201, 202, . . . 20n, such as a first live streaming audio and video data and a second live streaming audio and video data, the display engine 130 stitches the first live streaming audio and video data and the second live streaming audio and video data. It should be noted that the live streaming audio and video data 210 is not limited to including data generated by two streaming terminals. In other embodiments, the live streaming audio and video data 210 may include data generated by more than two streaming terminals, and the stitching method described herein may be applied accordingly.

In some embodiments, the display engine 130 further includes an image stitching module 131 and an image streaming module 132. In some embodiments, the image stitching module 131 receives the first live streaming audio and video data and the second live streaming audio and video data and processes the same. In some embodiments, the image stitching module 131 adjusts the resolutions of the received first live streaming audio and video data and the second live streaming audio and video data, such that the first live streaming audio and video data and the second live streaming audio and video data can be transmitted to the client terminals 301, 302, . . . 30n for preview by stitching the first live streaming audio and video data and the second live streaming audio and video data into a single image. In some embodiments, the image stitching module 131 adjusts the resolutions of the first live streaming audio and video data and the second live streaming audio and video data using a scaling function based on a final display interface size. In this embodiment, downscaling is performed so that the resolutions of the first live streaming audio and video data and the second live streaming audio and video data are changed after scaling, thereby forming first adjusted image data and second adjusted image data. Subsequently, the image stitching module 131 combines the first adjusted image data and the second adjusted image data into a stitched image data. In some embodiments, the display interface of the client terminals 301, 302, . . . 30n may display the first adjusted image data and the second adjusted image data of the stitched image data in a split-screen manner. The image streaming module 132 is coupled to the image stitching module 131 and streams the stitched image from the image stitching module 131 to form a streamed stitched image 212, which is transmitted to the client terminals 301, 302, . . . 30n via a network.

In some embodiments, the USB component 140 is coupled to the display engine 130 and is configured to perform format conversion on the streamed stitched image 212, converting the streamed stitched image 212 into USB-format live streaming audio and video data 310, which is then transmitted to the display interfaces of the client terminals 301, 302, . . . 30n for playback. The display interface may be, for example, a flat panel display, a television, a projector, a computer monitor, or the like, but the present disclosure is not limited thereto.

In some embodiments, the network livestream device 100 further includes a communication component 104 coupled to the processing component 102. The processing component 102 controls the communication component 104 to receive audio and video data from an external live streaming terminal, or to directly transmit, or transmit after conversion, the live streaming audio and video data, that is, the streamed stitched image 212, to a specific Internet address or other website for live streaming.

In some embodiments, the network livestream device 100 further includes High Definition Multimedia Interface (HDMI) input/output interfaces 106 and 107, which may directly output the streamed stitched image 212, or receive a live image transmitted from another party for image monitoring.

In some embodiments, the network livestream device 100 further includes an audio input interface 108 for coupling to an audio input device, such as a microphone. The audio input by the audio input device is mixed with the decoded live streaming audio and video data 211 and then transmitted to the display interfaces of the client terminals 301, 302, . . . 30n for playback after being formatted by the display engine 130 and the USB component 140.

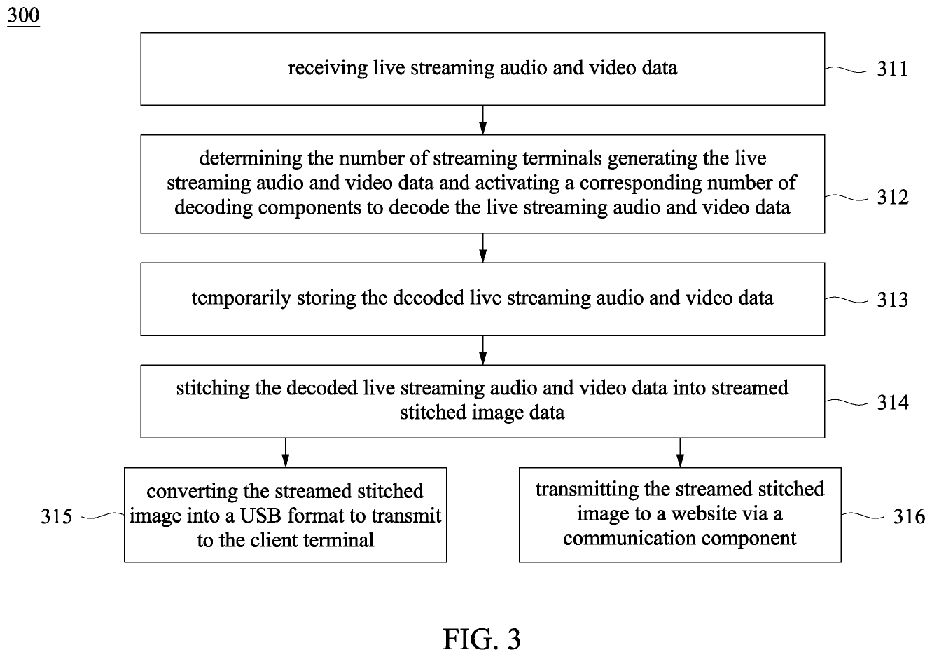

FIG. 3 is a flowchart of a network live streaming method according to a preferred embodiment of the present disclosure. Reference is made to FIGS. 1 to 3 concurrently. The network live streaming method 300 includes step 311 of receiving live streaming audio and video data. In some embodiments, a network livestream device 100 receives the live streaming audio and video data transmitted from the streaming terminals 201, 202, . . . 20n.

Step 312 involves determining the number of streaming terminals generating the live streaming audio and video data and activating a corresponding number of decoding components to decode the live streaming audio and video data. The processing component 102 of the network livestream device 100 determines the number of streaming terminals 201, 202, . . . 20n generating the live streaming audio and video data, and activates a corresponding number of decoding components 110, 111, . . . 11n to decode the live streaming audio and video data.

Step 313 involves temporarily storing the decoded live streaming audio and video data. In some embodiments, the frame buffer 121 in the memory component 120 temporarily stores the decoded live streaming audio and video data 211 from the plurality of decoding components 110, 111, . . . 11n.

Step 314 involves stitching the decoded live streaming audio and video data into streamed stitched image data. In some embodiments, the decoded live streaming audio and video data 211 includes first live streaming audio and video data and second live streaming audio and video data. The image stitching module 131 adjusts the resolutions of the first live streaming audio and video data and the second live streaming audio and video data to stitch the first live streaming audio and video data and the second live streaming audio and video data into a single stitched image. The image streaming module 132 streams the stitched image generated by the image stitching module 131 to form a streamed stitched image 212.

Next, in step 315, the streamed stitched image can be converted into a USB format and transmitted to the client terminal. In some embodiments, the USB component 140 performs format conversion on the streamed stitched image 212 to convert the streamed stitched image 212 into live streaming audio and video data 310 in USB-format, which is then transmitted to the display interfaces of the client terminals 301, 302, . . . 30n for playback.

Alternatively, in step 316, the streamed stitched image is directly transmitted to a website via a communication component. In one embodiment, the communication component 104 directly forwards the streamed stitched image 212 to a specific Internet address or another website for live streaming.

In summary, the network livestream device and method of the present disclosure are capable of directly receiving audio and video signals in different formats from one or more livestream devices, decoding the signals, and converting the signals into a USB signal format for use in network streaming, so as to output the signals to other playback devices. Therefore, a broadcaster does not need to prepare different capture devices or adapter cables to capture audio and video signals in different formats, thereby significantly reducing the burden and inconvenience associated with live streaming.

It will be apparent to those skilled in the art that various modifications and variations can be made to the structure of the present disclosure without departing from the scope or spirit of the disclosure. In view of the foregoing, it is intended that the present disclosure cover modifications and variations of this invention provided they fall within the scope of the following claims and their equivalents.

What is claimed is:

1. A network livestream device, comprising:
a processing component;
a plurality of decoding components coupled to the processing component and configured to receive live streaming audio and video data generated by at least one streaming terminal, wherein the processing component determines a number of the at least one streaming terminal and activates a corresponding number of the plurality of decoding components to decode the live streaming audio and video data to generate decoded live streaming audio and video data;
a display engine coupled to the plurality of decoding components and configured to adjust a resolution of the decoded live streaming audio and video data to form streamed stitched image data; and
a Universal Serial Bus (USB) component coupled to the display engine and configured to perform format conversion on the streamed stitched image data to generate USB-format live streaming audio and video data and transmit the USB-format live streaming audio and video data to at least one client terminal.

2. The network livestream device according to claim 1, further comprising a memory component coupled to the plurality of decoding components and configured to temporarily store the decoded live streaming audio and video data.

3. The network livestream device according to claim 1, further comprising a communication component coupled to the processing component and configured to receive audio and video data from a live streaming source terminal, or to directly transmit, or transmit after conversion, the streamed stitched image data to a website.

4. The network livestream device according to claim 1, further comprising a high-definition multimedia interface configured to output the streamed stitched image data.

5. The network livestream device according to claim 1, further comprising an audio input interface configured to be coupled to an audio input device.

6. The network livestream device according to claim 1, further comprising a high-definition multimedia interface configured to input live streaming image data.

7. The network livestream device according to claim 1, wherein the decoded live streaming audio and video data includes at least one live streaming audio and video data generated by different streaming terminals, and the display engine further comprises:
an image stitching module configured to adjust resolutions of the at least one live streaming audio and video data to form at least one adjusted image data, and to combine the at least one adjusted image data into stitched image data; and
an image streaming module coupled to the image stitching module and configured to stream the stitched image data to form the streamed stitched image data.

8. The network livestream device according to claim 7, wherein the image stitching module adjusts the resolutions of the at least one live streaming audio and video data using a scaling function.

9. A network livestream method, comprising:
receiving live streaming audio and video data generated by at least one streaming terminal, wherein a processing component determines a number of the at least one streaming terminal and activates a corresponding number of a plurality of decoding components to decode the live streaming audio and video data to generate decoded live streaming audio and video data;
adjusting a resolution of the decoded live streaming audio and video data to form streamed stitched image data; and
performing format conversion on the streamed stitched image data to generate USB-format live streaming audio and video data and transmitting the USB-format live streaming audio and video data to at least one client terminal.

10. The network livestream method according to claim 9, wherein the decoded live streaming audio and video data includes at least one live streaming audio and video data generated by different streaming terminals, and the method further comprises:
adjusting resolutions of the at least one live streaming audio and video data to form at least one adjusted image data and combining the at least one adjusted image data into stitched image data; and
streaming the stitched image data to form the streamed stitched image data.
